(19) United States
(12) Patent Application Publication
(10) Pub. No.: US 2004/0188550 A1
(43) Pub. Date: Sep. 30, 2004

(54) Fuel injection valve

(75) Inventors: Takahiro Saito, Gunma (JP); Hidehiko Koyashiki, Gunma (JP)

Correspondence Address: SUGHRUE MION, PLLC, 2100 PENNSYLVANIA AVENUE, N.W., SUITE 800, WASHINGTON, DC, 20037, US

(73) Assignee: HITACHI UNISIA AUTOMOTIVE, LTD.

(21) Appl. No.: 10/797,103

(22) Filed: Mar. 11, 2004

(30) Foreign Application Priority Data
Mar. 25, 2003 (JP) 2003-082776

(51) Int. Cl. F02M 51/00

(52) U.S. Cl. 239/533.12

(57) ABSTRACT

A valve seat member includes; a valve seat face allowing a valve body to be seated when the valve body is closed, and an injection port on downstream side of the valve seat face. A nozzle plate is connected to valve seat member and disposed on downstream side of injection port. The nozzle plate has nozzle holes radially outwardly with respect to injection port. A cross section of fuel passage is perpendicular to injection port, having diameter gradually increased. The fuel passage connects the injection port to nozzle holes.

### BACKGROUND OF THE INVENTION

1. Field of the Invention

The present invention relates to a fuel injection valve of an internal combustion engine and the like. Especially, the present invention relates to an art for accelerating atomization (or vaporization) of an injected (or sprayed) fuel.

2. Description of the Related Art

For decreasing fuel consumption and improving emission-purging of a fuel injection valve of an internal combustion engine, accelerating of the atomization (or vaporization) of fuel is preferred.

JP2002534638T (equivalent of WO0040855), a related art 1 discloses a fuel injection valve in which an injection port is defined in a valve seat member for allowing an electromagnetically-driven valve body to be seated thereon when a valve body is closed. A nozzle plate formed with a plurality of nozzle holes is mounted right below the injection port.

JP2001046919 (equivalent of U.S. Pat. No. 6,405,946), a related art 2 discloses a fluid injection nozzle. For preventing an overlapping of sprays of fuel, an outlet side of an injection port formed right below a valve seat face is increased in diameter, to thereby form a fluid chamber which is substantially in parallel to a nozzle plate. Opposed to the fluid chamber, a plurality of nozzle holes are formed radially outwardly with respect to the injection port.

### BRIEF SUMMARY OF THE INVENTION

It is an object of the present invention to provide a fuel injection valve of an internal combustion engine. The above fuel injection valve is capable of controlling (restricting) decrease in fuel speed and is formed with a plurality of nozzle holes which are spaced apart with each other at sufficient intervals, thereby sufficiently accelerating atomization (or vaporization) of fuel.

According to an aspect of the present invention, there is provided a fuel injection valve, comprising: a valve seat member and a nozzle plate.

1) The valve seat member includes;

a) a valve seat face for allowing a valve body to be seated thereon when the valve body is closed, and

b) an injection port formed on a downstream side of the valve seat face.

2) The nozzle plate is connected to the valve seat member and disposed on a downstream side of the injection port. The nozzle plate is formed with a plurality of nozzle holes. The nozzle holes are defined radially outwardly with respect to the injection port. A fuel passage has a cross section substantially perpendicular to an axis of the injection port. The cross section of the fuel passage has a diameter which is substantially gradually increased. The fuel passage is defined in such a manner as to connect the injection port of the valve seat member to the nozzle holes of the nozzle plate.

The other object(s) and feature(s) of the present invention will become understood from the following description with reference to the accompanying drawings.

### BRIEF DESCRIPTION OF THE SEVERAL VIEWS OF THE DRAWINGS

FIG. 1 shows a cross section of an overall view of a fuel injection valve of an internal combustion engine, according to a first embodiment of the present invention.

FIG. 2 is an enlarged view of an essential part of the fuel injection valve, according to the first embodiment.

FIG. 3 is a view of explaining about a cross section of a fuel passage of the fuel injection valve, according to the first embodiment.

FIG. 4 is a graph showing a change in the cross section of the fuel passage of the fuel injection valve according to the first embodiment of the present invention, as compared with JP2001046919 (equivalent of U.S. Pat. No. 6,405,946), a related art 2.

FIG. 5 an enlarged view of an essential part of the fuel injection valve, according to a second embodiment of the present invention.

FIG. 6 an enlarged view of an essential part of the fuel injection valve, according to a third embodiment of the present invention.

### DETAILED DESCRIPTION OF THE EMBODIMENT

In the following, various embodiments of the present invention will be described in detail with reference to the accompanying drawings.

For ease of understanding, the following description will contain various directional terms, such as left, right, upper, lower, forward, rearward and the like. However, such terms are to be understood with respect to only a drawing or drawings on which the corresponding part of element is illustrated.

<First Embodiment>

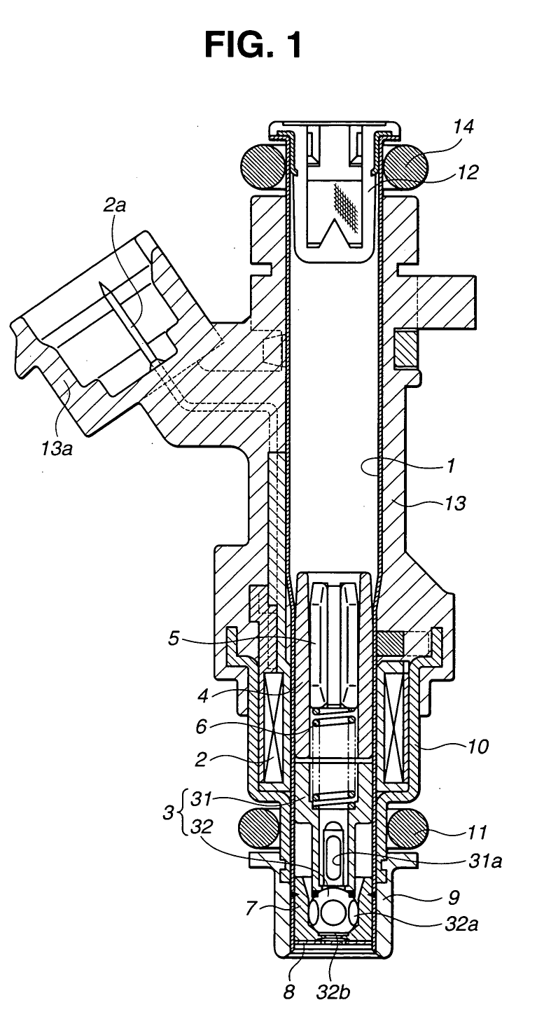

FIG. 1 shows a fuel injection valve of an internal combustion engine (gasoline engine) and the like, according to a first embodiment of the present invention.

An electromagnetic coil 2 is secured to an outer periphery of a casing pipe 1 which is made of a magnetic body. A valve body 3 which is an integration (through welding) of a barrel-shaped anchor 31 and a ball 32 is slidably inserted in casing pipe 1 substantially axially. Around a lower end wall of anchor 31, there is opened a fuel through hole 31a. A plurality of first flat faces 32a are formed by cutting a periphery of ball 32. A second flat face 32b is formed by cutting a lower end of ball 32. With a certain clearance defined substantially above valve body 3 (anchor 31), a barrel-shaped spring housing 4 is secured to an inner wall of casing pipe 1. A barrel-shaped spring stopper 5 is securely inserted in spring housing 4. Between a lower end of spring stopper 5 and a stepped section 31 b of anchor 31, a return spring 6 is compressively inserted.

A valve seat member 7 is connected by welding to an inner periphery at a lower end of casing pipe 1. Valve seat member 7 allows ball 32 of valve body 3 to be seated thereon. Substantially a center section of valve seat member 7 is formed with an injection port 7c. A nozzle plate 8 formed with a plurality of nozzle holes 8a is connected by welding to a lower end of valve seat member 7.

A cap member 9 is fixed to an outer periphery at the lower end of casing pipe 1. A coil cover 10 for covering an outer periphery of electromagnetic oil 2 has a lower end section which is connected by welding to casing pipe 1.

A seal member 11 is inserted in an area between an upper end flange section of cap member 9 and a stepped section 10a of coil cover 10.

A fuel filter 12 is securely inserted in an upper end section of casing pipe 1.

A resin casing 13 is molded substantially into the following area 1 and area 2:

Area 1 from an upper end section of coil cover 10 to the upper end section of casing pipe 1.

Area 2 covering electromagnetic oil 2, excluding an end section of a lead 2a.

A seal member 14 is inserted in an area between an upper end face of resin casing 13 and a flange face 1 a at the upper end section of casing pipe 1.

Resin casing 13 is formed with a connector section 13a surrounding the end section of lead 2a of electromagnetic coil 2.

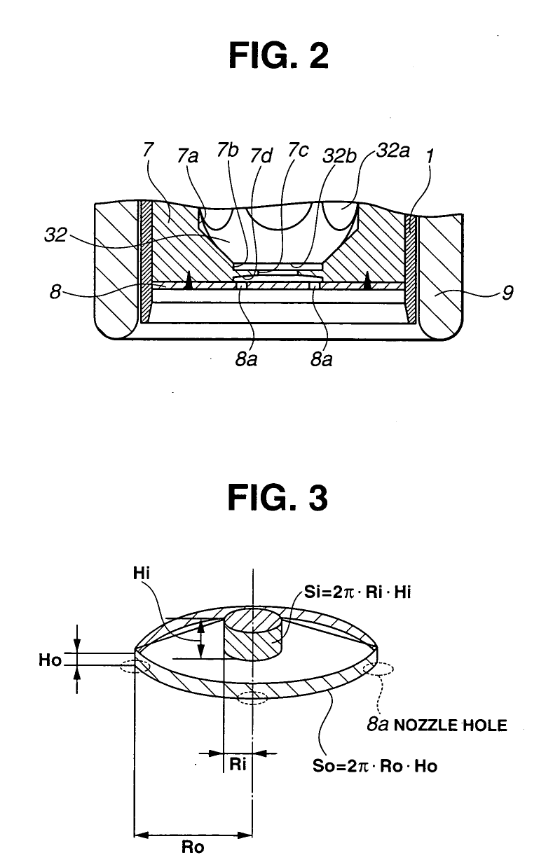

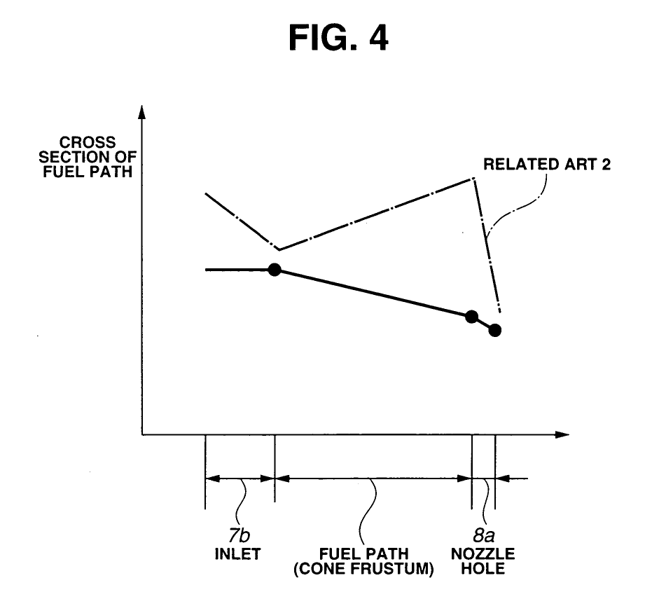

With electromagnetic coil 2 not energized, a resilient compressive force of return spring 6 may allow valve body 3 to be seated on a valve seat face 7a (see FIG. 2) of valve seat member 7, thus bringing about a closed valve state.

Hereinafter described in detail referring to FIG. 2 is a fuel injection section of the fuel injection valve, according to the first embodiment of the present invention.

Valve seat face 7a of valve seat member 7 is shaped substantially into a taper. Below valve seat face 7a, there is defined an inlet 7b having a diameter which is slightly greater than a diameter of second flat face 32b of ball 32 of valve body 3. Below inlet 7b, there is defined injection port 7c having a diameter which is smaller than the diameter of inlet 7b.

An outlet 7d is so defined below injection port 7c of valve seat member 7 as to form a taper having a diameter which is increased downwardly. With the above constitution of valve seat member 7, a fuel passage can be defined between outlet 7d and an upper face of nozzle plate 8. More specifically about this: The fuel passage is shaped substantially into a frustum of cone which has a cross section substantially gradually increased in diameter in a direction substantially perpendicular to an axis of injection port 7c. The fuel passage can form a connection from injection port 7c to nozzle holes 8a (of nozzle plate 8) which are defined radially outwardly with respect to injection port 7c.

Hereinafter described is operation of the fuel injection valve, according to the first embodiment of the present invention.

A fuel which is force-fed by means of a fuel pump (not shown) is introduced in casing pipe 1 from fuel filter 12 by way of a fuel pipe (not shown). Then, the fuel may be conveyed in barrel-shaped spring stopper 5 and barrel-shaped anchor 31. Then, the fuel may outflow into a space out of fuel through hole 31 a, thereby filling an area defined from a gap (between first flat face 32a of ball 32 and valve seat face 7a) to a section (closed by an abutment of ball 32 with valve seat face 7a).

With electromagnetic coil 2 energized, an electromagnetic force may lift valve body 3 (made of a magnetic body) upward against a biasing force by return spring 6, thereby allowing an upper end face of anchor 31 to make a stroke to a position for abutting on a lower end face of spring housing 4.

With the above operation of the fuel injection valve, ball 32 of valve body 3 may be spaced apart from valve seat face 7a, thus bringing about an open valve state. Then, the fuel may flow in inlet 7b (greater diameter) and then outflow from outlet 7d through injection port 7c (smaller diameter). Then, the fuel may be injected substantially radially through the plurality of nozzle holes 8a, forming a spray shaped substantially into a cone.

Hereinafter described is a cross section of the fuel passage which is shaped substantially into the frustum of cone extending from inlet 7b to an end of nozzle holes 8a. More specifically, the cross section of the fuel passage is substantially perpendicular to a direction of fuel flow.

A cross section of the fuel passage at injection port 7c (smaller diameter) is obviously smaller than a cross section of the fuel passage at inlet 7b (greater diameter).

The fuel outflowing from injection port 7c may be conveyed to the frustum of cone of the fuel passage, converting the direction of fuel flow from “axially downwardly (at injection port 7c)” to “radially outwardly.”

With this, the cross section of the fuel passage from outlet 7d to nozzle holes 8a can be, as is seen in FIG. 3, expressed as a cross section of a cylinder which is defined substantially around a center axis of injection port 7c.

The following expression 1 can be obtained:

Expression 1: Si=2π·Ri·Hi

where

Si is an inlet cross section,

Ri is a radius of injection port 7c, and

Hi is a height from the upper face of nozzle plate 8.

Moreover, the following expression 2 can be obtained:

Expression 2: So=2π·Ro·Ho

where

So is an outlet cross section on nozzle holes 8a,

Ro is a radius in this position, and

Ho is a height from the upper face of nozzle plate 8.

Forming a ceiling shaped substantially into a taper from the inlet to the outlet can make radius Ro greater than radius Ri and height Ho smaller than height Hi, and can allow a height H smaller in accordance with an increase in radius R from the inlet to the outlet, thereby controlling (restricting) increase in the cross section of the fuel passage covering the above region.

Especially, setting up an angle of the taper such that “outlet cross section So=inlet cross section Si” and thereby “Hi/Ho=Ro/Ri” can make the cross section of the fuel passage substantially constant from the inlet to the outlet. On the other hand, setting up a greater angle of the taper such that “inlet cross section Si>outlet cross section So” and thereby “Hi/Ho>Ro/Ri” can decrease the cross section of the fuel passage at a constant rate from the inlet to the outlet.

Setting a total cross section Sn, namely, cross sections of the plurality of nozzle holes 8a smaller than or equal to outlet cross section So may substantially monotonously decrease the cross section of the fuel passage from inlet 7b to nozzle holes 8a.

As described above, forming the fuel passage shaped substantially into the frustum of cone which is substantially gradually increased in diameter (of cross section) from the outlet of injection port 7c to nozzle holes 8a can control (restrict) the increase in the cross section of the fuel passage from an upstream side to a downstream side of the fuel passage, or can decrease the cross section of the above fuel passage, thereby restricting decrease in fuel speed otherwise increase the fuel speed. Moreover, the plurality of nozzle holes 8a sufficiently spaced apart radially outwardly with respect to injection port 7c can restrict an overlapping of sprays from each of nozzle holes 8a.

The above constitution of the fuel injection valve according to the first embodiment can accelerate atomization (or vaporization) of the fuel as much as possible.

<Second Embodiment>

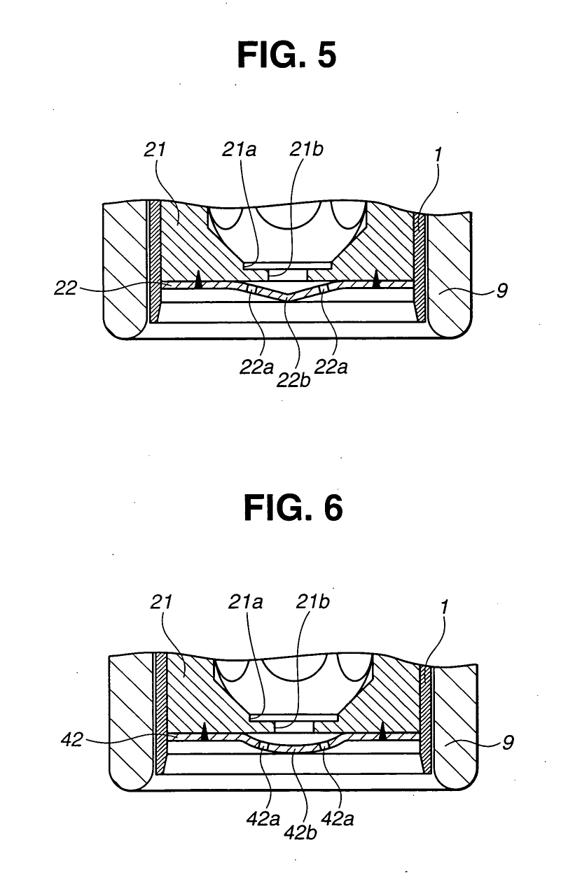

Hereinafter described in detail referring to FIG. 5 is the fuel injection section of the fuel injection valve, according to a second embodiment of the present invention.

According to the second embodiment, as an injection port, a valve seat member 21 is formed with an inlet 21a (greater diameter) and an injection port 21b (smaller diameter). On a nozzle plate 22's side, there is formed a taper section 22b which is so tapered as to be substantially gradually increased in diameter from substantially a center section to a plurality of nozzle holes 22a. Nozzle holes 22 are so defined radially outwardly relative to the center section as to be opposed to injection port 21b.

With the above constitution of the fuel injection valve according to the second embodiment, the fuel passage can be formed between an outlet of inlet 21a and an upper face of nozzle plate 22, like the fuel injection valve according to the first embodiment. More specifically about this: The fuel passage is shaped substantially into a frustum of cone which has a cross section substantially gradually increased in diameter in a direction substantially perpendicular to an axis of injection port 21b. The fuel passage can form a connection from injection port 21b to nozzle holes 22a (of nozzle plate 22) which are defined radially outwardly with respect to injection port 21b.

The above constitution of the fuel injection valve according to the second embodiment can accelerate the atomization (or vaporization) of the fuel as much as possible, like the constitution of the fuel injection valve according to the first embodiment.

<Third Embodiment>

Hereinafter described in detail referring to FIG. 6 is the fuel injection section of the fuel injection valve, according to a third embodiment of the present invention.

In place of taper 22b shaped substantially into the frustum of cone according to the second embodiment, the fuel injection valve according to the third embodiment has a curved section 42b. On a nozzle plate 42's side, there is formed curved section 42b which is so curved as to be substantially gradually increased in diameter from substantially a center section to a plurality of nozzle holes 42a. Nozzle holes 42a are so defined radially outwardly relative to the center section as to be opposed to injection port 21b.

Hereinafter described is a technical concept as well as an effect arising therefrom which concept is obtainable from the first embodiment, the second embodiment and the third embodiment of the present invention.

1) From inlet 7b, 21a, 21a to nozzle holes 8a, 22a, 42a of the fuel injection valve, the cross section of the fuel passage is formed substantially constant or substantially gradually decreased.

With the above constitution, the fuel speed in the fuel passage can be made constant or increased, thereby accelerating the atomization (or vaporization) of the fuel.

2) From injection port 7c, 21b, 21b of valve seat member 7, 21, 21 to nozzle holes 8a, 22a, 42a by way of the fuel passage of the fuel injection valve, the cross section of the fuel passage is decreased substantially monotonously.

With the above constitution, the fuel speed of the fuel injected from nozzle holes 8a, 22a, 42a by way of the fuel passage can be made constant or increased, thereby further accelerating the atomization (or vaporization) of the fuel.

Although the present invention has been described above by reference to three embodiments, the present invention is not limited to the three embodiment described above. Modifications and variations of the embodiments described above will occur to those skilled in the art, in light of the above teachings.

This application is based on a prior Japanese Patent Application No. P2003-082776 (filed on Mar. 25, 2003 in Japan). The entire contents of the Japanese Patent Application No. P2003-082776 from which priority is claimed is incorporated herein by reference, in order to take some protection against mis-translation or omitted sections.

The scope of the present invention is defined with reference to the following claims.

What is claimed is:

1. A fuel injection valve, comprising:
1) a valve seat member including;
a) a valve seat face for allowing a valve body to be seated thereon when the valve body is closed, and
b) an injection port formed on a downstream side of the valve seat face; and
2) a nozzle plate connected to the valve seat member and disposed on a downstream side of the injection port, the nozzle plate being formed with a plurality of nozzle holes, the nozzle holes being defined radially outwardly with respect to the injection port, a fuel passage having a cross section substantially perpendicular to an axis of the injection port, the cross section of the fuel passage having a diameter which is substantially gradually increased, the fuel passage being defined in such a manner as to connect the injection port of the valve seat member to the nozzle holes of the nozzle plate.

2. The fuel injection valve as claimed in claim 1, wherein
the fuel passage is so formed in the valve seat member as to be shaped substantially into a cone having a diameter which is substantially gradually and continuously increased toward an outlet of the injection port.

3. The fuel injection valve as claimed in claim 2, wherein
the fuel passage is so formed in the valve seat member as to be shaped substantially into a frustum of the cone.

4. The fuel injection valve as claimed in claim 1, wherein
the fuel passage is formed by tapering, such that a section is so formed as to have a diameter which is substantially gradually increased from substantially a center section of the nozzle plate to the nozzle holes which are defined radially outwardly with respect to the center section, the center section of the nozzle plate being opposed to the injection port.

5. The fuel injection valve as claimed in claim 1, wherein
the fuel passage is formed by curving, such that a section is so formed as to have a diameter which is substantially gradually increased from substantially a center section of the nozzle plate to the nozzle holes which are defined radially outwardly with respect to the center section, the center section of the nozzle plate being opposed to the injection port.

6. The fuel injection valve as claimed in claim 3, wherein
a fuel outflowing from the injection port is conveyed to the frustum of the cone of the fuel passage, converting a direction of a fuel flow from axially downwardly to radially outwardly,
the cross section of the fuel passage from the outlet to the nozzle holes is expressed as a cross section of a cylinder which is defined substantially around a center axis of the injection port,
a following expression 1 is obtained:
expression 1: Si=2π·Ri·Hi
where
Si is an inlet cross section,
Ri is a radius of injection port, and
Hi is a height from the upper face of the nozzle plate,
a following expression 2 is obtained:
expression 2: So=2π·Ro·Ho
where
So is an outlet cross section on the nozzle holes,
Ro is a radius in this position, and
Ho is a height from the upper face of nozzle plate,
forming a ceiling shaped substantially into a taper from an inlet to the outlet makes the radius Ro greater than the radius Ri and the height Ho smaller than the height Hi, and allows a height H smaller in accordance with an increase in the radius R from the inlet to the outlet, thereby controlling an increase in the cross section of the fuel passage covering the above region,
setting up an angle of a taper such that the outlet cross section So=the inlet cross section Si and thereby Hi/Ho=Ro/Ri makes the cross section of the fuel passage substantially constant from the inlet to the outlet, while setting up a greater angle of the taper such that the inlet cross section Si>the outlet cross section So and thereby Hi/Ho>Ro/Ri decreases the cross section of the fuel passage at a constant rate from the inlet to the outlet, and
setting a total cross section Sn which is cross sections of the plurality of the nozzle holes smaller than or equal to the outlet cross section So substantially monotonously decreases the cross section of the fuel passage from the inlet to the nozzle holes.

7. The fuel injection valve as claimed in claim 4, wherein
from an inlet to the nozzle holes of the fuel injection valve, the cross section of the fuel passage is formed substantially constant or substantially gradually decreased, with this, a fuel speed in the fuel passage is made constant or increased, thereby accelerating at least one of an atomization and a vaporization of a fuel, and
from the injection port of the valve seat member to the nozzle holes by way of the fuel passage of the fuel injection valve, the cross section of the fuel passage is decreased substantially monotonously, with this, the fuel speed of the fuel injected from the nozzle holes by way of the fuel passage is made constant or increased, thereby further accelerating the at least one of the atomization and the vaporization of the fuel.

8. The fuel injection valve as claimed in claim 5, wherein
from an inlet to the nozzle holes of the fuel injection valve, the cross section of the fuel passage is formed substantially constant or substantially gradually decreased, with this, a fuel speed in the fuel passage is made constant or increased, thereby accelerating at least one of an atomization and a vaporization of a fuel, and
from the injection port of the valve seat member to the nozzle holes by way of the fuel passage of the fuel injection valve, the cross section of the fuel passage is decreased substantially monotonously, with this, the fuel speed of the fuel injected from the nozzle holes by way of the fuel passage is made constant or increased, thereby further accelerating the at least one of the atomization and the vaporization of the fuel.
